(19) United States
(12) Patent Application Publication
(10) Pub. No.: US 2023/0013340 A1
(43) Pub. Date: Jan. 19, 2023

(54) APPARATUS FOR MACHINE LEARNING SERVICE, METHOD FOR MACHINE LEARNING SERVICE AND PROGRAM THEREOF

(71) Applicant: NIPPON TELEGRAPH AND TELEPHONE CORPORATION, Tokyo (JP)

(72) Inventors: Chao WU, Musashino-shi, Tokyo (JP); Shingo HORIUCHI, Musashino-shi, Tokyo (JP); Kenichi TAYAMA, Musashino-shi, Tokyo (JP)

(73) Assignee: NIPPON TELEGRAPH AND TELEPHONE CORPORATION, Tokyo (JP)

(21) Appl. No.: 17/783,352

(22) PCT Filed: Dec. 9, 2019
(86) PCT No.: PCT/JP2019/048024

§ 371 Date: Jun. 8, 2022

(51) Int. Cl. G06N 20/00; G06F 9/50

(52) U.S. Cl. CPC G06N 20/00; G06F 9/5027; G06F 2209/5019; G06F 2209/501

(57) ABSTRACT

To eliminate the need for a resource design process needed by the user in using a machine learning service and thereby reduce the time and costs which impose a burden on the user.

A machine learning service device includes a requirement specifying functional unit (11) used to specify a task, a model, throughput, and performance that are desired in machine learning; and a resource design unit (12) configured to predict achievable performance at a plurality of resource settings by machine learning using the task, the model, and the throughput specified via the requirement specifying functional unit and select a resource setting that satisfies the specified performance based on results of the prediction.

### TECHNICAL FIELD

The present invention relates to a machine learning service device, a machine learning service method, and a program.

### BACKGROUND ART

When a user uses machine learning via cloud computing (hereinafter referred to as cloud), requirements the user is generally interested in mainly include performance requirements such as processing time and throughput. To satisfy these requirements, it is essential to precisely set amounts of resources such as the number of vCPUs, amounts of memory, and storage placed on a VM (Virtual Machine). In conventional machine learning services (MLaaS: Machine Learning as a Service), for such resource design, users, i.e., human resources having technical knowledge of cloud environment, need to repeat a cycle of implementation-observation-adjustment, requiring enormous amounts of time and costs.

Incidentally, a large number of techniques for implementing machine learning services have been proposed (e.g., Non-Patent Literatures 1 to 3).

### CITATION LIST

### Non-Patent Literature

Non-Patent Literature 1: “Mauro Ribeiro, Katarina Grolinger, Miriam A. M. Capretz, “MLaaS: Machine Learning as a Service”, 2015 IEEE 14th International Conference on Machine Learning and Applications.”
Non-Patent Literature 2: URL [https://cloud.google.com/ml-engine/] viewed on Dec. 2, 2019
Non-Patent Literature 3: URL [https://aws.amazone.com/jp/sagemaker/pricing/] viewed on Dec. 2, 2019

### SUMMARY OF THE INVENTION

### Technical Problem

The technique described in Non-Patent Literature 1 does not discuss a technical method that satisfies performance requirements and the like, which are MLaaS user requirements. Both the techniques described in Non-Patent Literatures 2 and 3 make it necessary for the user to select amounts of resources, requiring resource design tailored to performance requirements of the user.

In this way, under present circumstances, in using a machine learning service in the cloud, enormous amounts of time and costs are required for the user to design the amounts of resources, imposing a heavy burden.

The present invention has been made in view of the above circumstances and has an object to provide a machine learning service device, a machine learning service method, and a program that can eliminate the need for a resource design process needed by the user in using a machine learning service and thereby reduce the time and costs which impose a burden on the user.

### Means for Solving the Problem

One aspect of the present invention comprises: a requirement specifying functional unit used to specify a task, a model, throughput, and performance that are desired in machine learning; and a resource design unit configured to predict achievable performance at a plurality of resource settings by machine learning using the task, the model, and the throughput specified via the requirement specifying functional unit and select a resource setting that satisfies the specified performance based on results of the prediction.

### Effects of the Invention

One aspect of the present invention makes it possible to eliminate the need for a resource design process needed by the user in using a machine learning service and thereby reduce the time and costs which impose a burden on the user.

### BRIEF DESCRIPTION OF DRAWINGS

FIG. 1 is a block diagram showing part of a functional configuration of a machine learning service device according to an embodiment.

FIG. 2 is a block diagram mainly showing a functional configuration of a resource design unit according to the embodiment.

FIG. 3 is a diagram illustrating by example a display screen used to specify user requirements according to the embodiment.

FIG. 4 is a diagram illustrating by example a display screen used to specify user requirements according to the embodiment.

FIG. 5 is a diagram illustrating by example a display screen used to specify user requirements according to the embodiment.

FIG. 6 is a diagram illustrating by example a display screen used to specify user requirements according to the embodiment.

FIG. 7 is a diagram illustrating by example a display screen used to specify user requirements according to the embodiment.

FIG. 8 is a diagram illustrating by example a display screen used to specify user requirements according to the embodiment.

FIG. 9 is a diagram illustrating by example a display screen used to specify user requirements according to the embodiment.

FIG. 10 is a diagram illustrating by example a display screen for implementation instructions according to the embodiment.

FIG. 11 is a diagram showing an example of log data collected by a log data collection section according to the embodiment.

FIGS. 12(A) to 12(C) are diagrams showing evaluation examples of prediction accuracy of a generated model according to the embodiment.

FIGS. 13(A) to 13(D) are diagrams showing prediction results and actual measurement results at resource settings specified by the user according to the embodiment.

### DESCRIPTION OF EMBODIMENTS

Detailed description will be given below with reference to the drawings by taking as an example an embodiment in which the present invention is applied to a machine learning service device that provides a machine learning service via cloud computing.

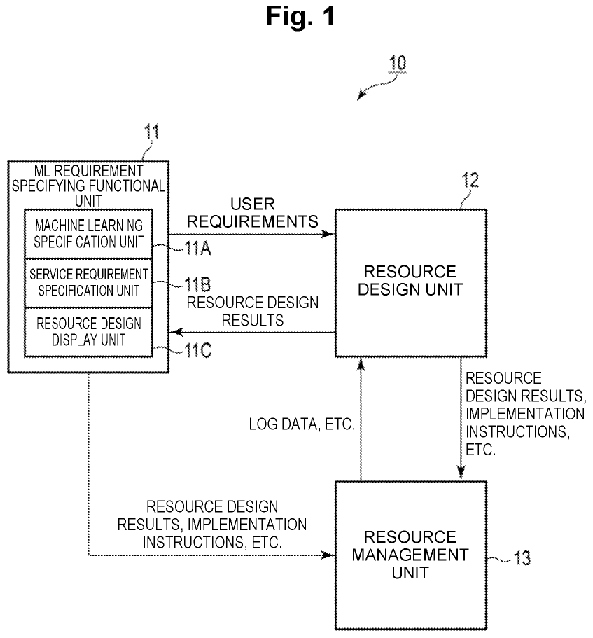

FIG. 1 is a block diagram showing a functional configuration of that part of a machine learning service device 10 according to an embodiment which is involved in resource design. In FIG. 1, the machine learning service device 10 includes an ML requirement specifying functional unit 11, a resource design unit 12, and a resource management unit 13.

The ML requirement specifying functional unit 11 includes an input unit (not shown) such as a typical keyboard and collects user requirements for machine learning, outputs user requirements to the resource design unit 12, receives and displays resource design results obtained from the resource design unit 12, and gives implementation instructions. Specifically, the ML requirement specifying functional unit 11 is made up of a machine learning specification unit 11A, a service requirement specification unit 11B and a resource design display unit 11C.

The machine learning specification unit 11A includes a task specification unit, a model specification unit, and a throughput specification unit.

The task specification unit allows the user to specify, for example, machine learning tasks such as image classification, voice recognition, and training/prediction.

The model specification unit allows the user to specify a model—specifically, a model type, a model layer structure, a neuron type, an activation function, and the like—used to implement a task specified via the task specification unit.

The throughput specification unit allows the user to specify, for example, amounts of processing such as the size and number of images desired to be classified and the length of speech.

The service requirement specification unit 11B includes a machine learning performance requirement specification unit and a VM performance requirement specification unit.

In processing the task by the throughput specified via the throughput specification unit using the model specified via the model specification unit, the machine learning performance requirement specification unit allows the user to specify, for example, processing time and the like as performance requirements desired to be achieved in machine learning.

In processing the task by the throughput specified via the throughput specification unit using the model specified via the model specification unit, the VM performance requirement specification unit allows the user to specify, for example, utilization rates and the like of CPUs and memory resources in the VM as VM performance requirements desired to be achieved.

The resource design display unit 11C displays recommend resources, machine learning performance prediction, and VM performance prediction on a display to the user.

The recommend resources are concrete content of resource settings that can satisfy specified user requirements in view of resource design results received from the resource design unit 12.

The machine learning performance prediction is concrete content of machine learning performance achievable at each resource setting in view of resource design results received from the resource design unit 12.

The VM performance prediction is concrete content of VM performance achievable at each resource setting in view of resource design results received from the resource design unit 12.

The resource design unit 12 carries out resource design according to the user requirements specified via the ML requirement specifying functional unit 11 and returns resource design results thus obtained to the ML requirement specifying functional unit 11.

The resource design unit 12 receives and collects log data and the like sent from the resource management unit 13 and outputs resource design results, implementation instructions, and the like obtained by processing the resource design to the resource management unit 13.

The ML requirement specifying functional unit 11 also outputs resource design results, implementation instructions, and the like to the resource management unit 13 at the direction of the user.

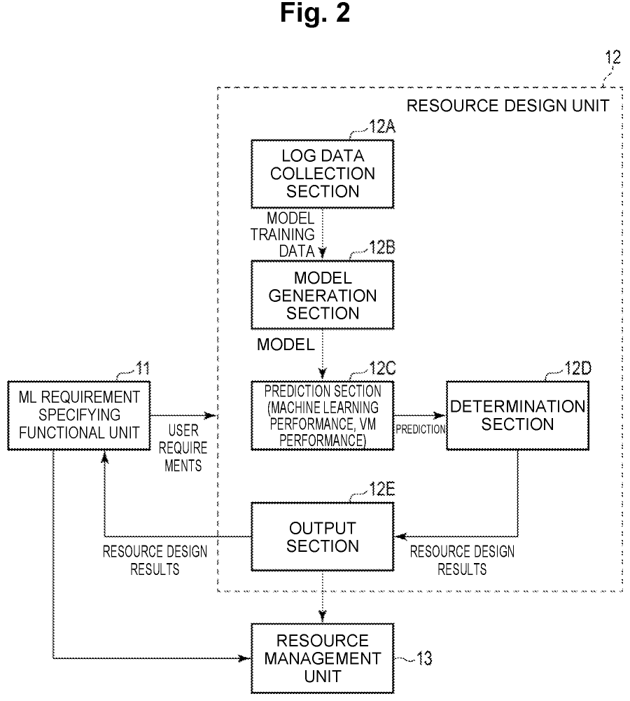

FIG. 2 is a block diagram mainly showing a functional configuration of the resource design unit 12. The resource design unit 12 is a functional unit configured to calculate the amounts of resources that satisfy the user requirements specified via the ML requirement specifying functional unit 11 and includes a log data collection section 12A, a model generation section 12B, a prediction section 12C, a determination section 12D, and an output section 12E.

The log data collection section 12A is a functional unit configured to collect log data of performance under applicable conditions by varying a model configuration, throughput, and resources placed in the VM with respect to a conceivable task of an applicable machine learning application and perform reformatting, integration, preprocessing, and the like.

The log data is sent out as data for model training from the log data collection section 12A to the model generation section 12B.

Using the log data from the log data collection section 12A as model training data, the model generation section 12B generates a machine learning performance model and VM performance model for predicting performance achievable under applicable resource setting conditions when producing specified throughput using a machine learning model specified by the user via the ML requirement specifying functional unit 11, and sends out the generated models to the prediction section 12C.

Using the machine learning performance model and VM performance model generated by the model generation section 12B, the prediction section 12C predicts performances achievable under applicable resource setting conditions when producing specified throughput and sends out prediction results on the respective performances to the determination section 12D.

The determination section 12D selects the resource settings that can satisfy the requirements specified by the user, collectively as resource design results from the respective prediction results on the machine learning performance and VM performance obtained from the prediction section 12C and sends out the resource settings to the output section 12E.

The output section 12E converts the resource design results obtained from the determination section 12D into a data format compatible with both ML requirement specifying functional unit 11 and resource management unit 13 and outputs the resource design results to the ML requirement specifying functional unit 11 and the resource management unit 13.

Next, an operation example of concrete implementation of the present embodiment will be described.

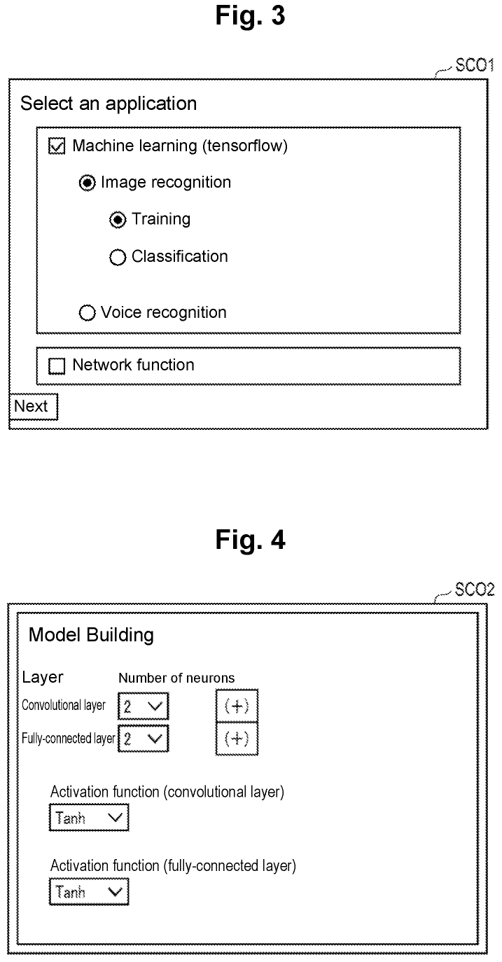

FIGS. 3 to 10 illustrate by example transition of a display screen on the resource design display unit 11C from when user requirements are specified to when implementation is ordered, via the ML requirement specifying functional unit 11.

FIG. 3 illustrates by example a display screen SC01 brought up on the resource design display unit 11C and used to specify via the task specification unit of the machine learning specification unit 11A whether machine learning will be done, what will be recognized, and which phase is concerned, a training (learning) phase or a classification phase of learning results. FIG. 3 shows that a Training phase is selected and specified to perform Image Recognition by Machine Learning.

FIG. 4 illustrates by example a display screen SC02 brought up on the resource design display unit 11C and used to build and specify a machine learning model via the model headquarters of the machine learning specification unit 11A. FIG. 4 shows a state in which the Number of Neurons in Layer is set to “2” in the case of Convolutional Layer and set to “2” in the case of Fully-connected Layer and “Tank (hyperbolic tangent function)” is selected and specified for Activation Function of Convolutional Layer and “Tank” is selected and specified similarly for Activation Function of Fully-connected Layer.

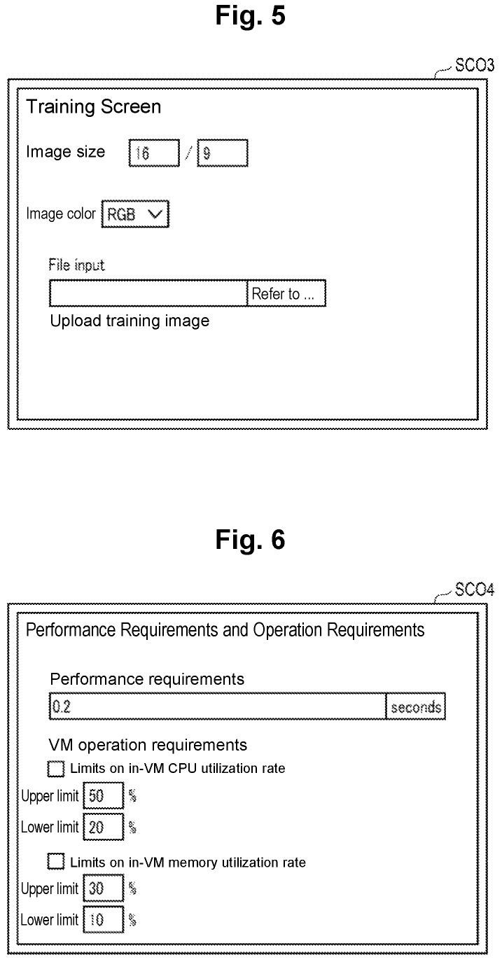

FIG. 5 illustrates by example a display screen SC03 brought up on the resource design display unit 11C and used to specify throughput of a training image via the throughput specification unit of the machine learning specification unit 11A. In FIG. 5, Image Size (horizontal pixel count/vertical pixel count) is set to “16/19” and Image Color is set to “RGB” primary colors, and a field for use to specify an input folder of the image file and a button for use to start Uploading Training Image are displayed.

FIG. 6 illustrates by example a screen SC04 brought up on the resource design display unit 11C and used to specify performance requirements and operation requirements via the machine learning performance requirement specification unit and VM performance requirement specification unit of the service requirement specification unit 11B. FIG. 6 shows an upper limit of training time as performance requirements; and VM operation requirements including whether the in-VM CPU utilization rate is to be limited, an upper limit (%) and a lower limit (%) if the CPU utilization rate is limited, whether the in-VM memory utilization rate is to be limited, and an upper limit (%) and a lower limit (%) if the memory utilization rate is limited.

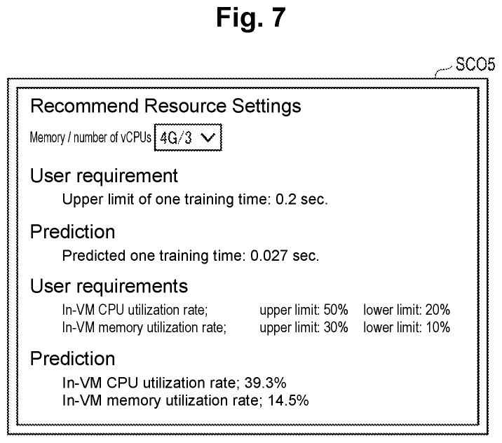

FIGS. 7 to 9 illustrate by example display screens SC05, SC06, and SC07 brought up on the resource design display unit 11C in making recommend resource settings. The display screen SC05 displays: memory and the number of virtual CPUs (vCPUs) as recommend resources; an upper limit value of one training time as a user requirement; one predicted training time as a prediction; an upper limit (%) and lower limit (%) of the in-VM CPU utilization rate and an upper limit (%) and lower limit (%) of the in-VM memory utilization rate as user requirements; and in-VM CPU utilization rate (%) and in-VM memory utilization rate (%) as predictions.

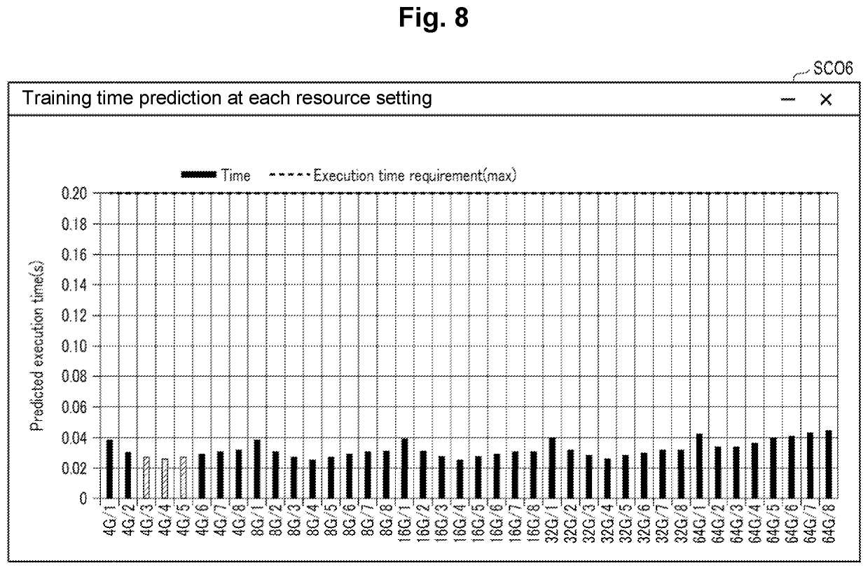

On the display screen SC06, the abscissa represents resource settings (memory/the number of vCPUs) and the ordinate represents predicted execution time at each resource setting. The broken line in FIG. 8 represents the upper limit of execution time (=0.2 sec.), which is a user-specified requirement.

As illustrated in FIG. 8, by assuming that the resource settings of “4G/3 (the memory capacity is 4 Gbytes and the number of vCPUs is 3),” “4G/4,” and “4G/5” are resource settings (recommend resources) that satisfy the upper limit of execution time and all the limits of in-VM resource utilization rates as user requirements, these resource settings are indicated by hatched bar graphs in distinction from other resource settings.

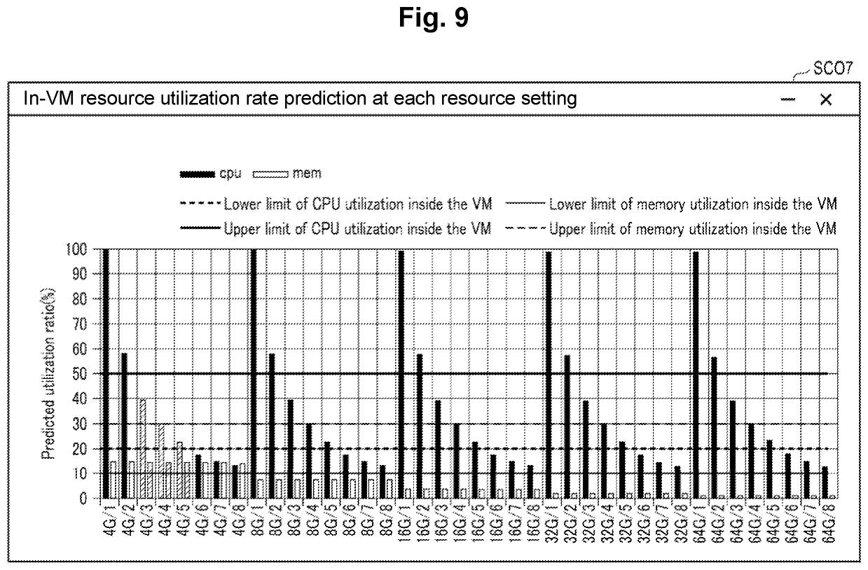

On the display screen SC07, the abscissa represents resource settings (at each setting, the black bar on the left side indicates the memory and the white bar on the right side indicates the number of vCPUs) and the ordinate represents predicted execution time at each resource setting. In FIG. 9, the thick solid line indicates the upper limit (=50%) and the thick broken line indicates the lower limit (=20%) of the in-VM CPU resource utilization rate, which is a user-specified requirement while the thin broken line indicates the upper limit (=30%) and the thin solid line indicates the lower limit (=10%) of the in-VM memory resource utilization rate, which is a user-specified requirement.

As illustrated in FIG. 9, by assuming that the resource settings of “4G/3 (the memory capacity is 4 Gbytes and the number of vCPUs is 3),” “4G/4,” and “4G/5” are resource settings (recommend resources) that satisfy the upper limit of execution time and all the limits of in-VM resource utilization rates as user requirements, these resource settings are indicated by hatched bar graphs in distinction from other resource settings.

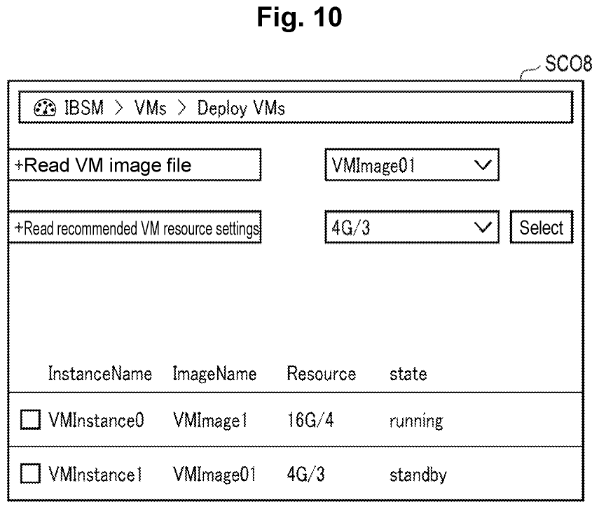

FIG. 10 illustrate by example a display screen SC10 brought up on the resource design display unit 11C in order for the user to give implementation instructions. FIG. 10 displays a folder name “VMImage01” indicating a destination of a VM image file, “4G/3” indicating one of read recommended VM resource settings, a Select button, destinations of respective image files of instances “VMInstance0” and “VMInstance1” specified to be implemented, resource settings, and execution status (“running” or “standby”). This allows the user to select user requirements and recommended resource settings for optimal performance and order implementation of the VM.

Next, operation on the side of the resource design unit 12 given implementation instructions via the ML requirement specifying functional unit 11 will be described.

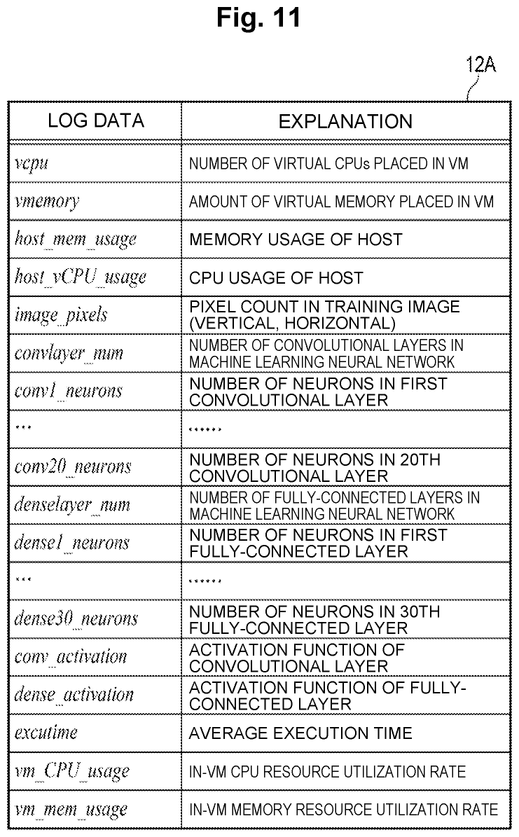

FIG. 11 is a diagram showing an example of log data collected by the log data collection section 12A of the resource design unit 12.

Using log data collected by the log data collection section 12A as model training data, the model generation section 12B generates a model by various analytical methods. In an implementation example, the model is trained based on the log data using a neural network. Prediction accuracy with regard to test data by the use of a trained model is shown in FIG. 12.

FIGS. 12(A) to 12(C) are diagrams showing evaluation examples of prediction accuracy of a model generated by the model generation section 12B. FIG. 12(A) shows an example in which execution time was predicted with an accuracy of 90.6%. FIG. 12(B) shows an example in which in-VM memory resource utilization rate was predicted with an accuracy of 95.8%. FIG. 12(C) shows an example in which in-VM CPU resource utilization rate was predicted with an accuracy of 98.7%.

Note that in the examples, a tuned neural network model was used and the number of log data sets (for training) was 23,046 and the number of test data sets was 4,609.

Using a model generated by the model generation section 12B, the prediction section 12C and the determination section 12D make resource settings. The prediction section 12C predicts performance in each resource setting. The determination section 12D selects a resource setting that satisfies user requirements, based on the performance predicted by the prediction section 12C.

As an example, consider a case in which image classification training is specified as a task by the machine learning specification unit 11A of the ML requirement specifying functional unit 11.

It is assumed that concrete content of model specification is, for example, as follows:

“input layer
conv(10,sig)
conv(10,sig)
conv(10,sig)
conv(10,sig)
conv(10,sig)
conv(10,sig)
flatten
dense (10, relu)
dense (15, relu)
dense (15, relu)
dense (15, relu)
output layer”

At the same time, it is assumed that throughput is specified by the service requirement specification unit 11B of the ML requirement specifying functional unit 11 as follows: 64*64 pixels; 10,000 RGB images.

That is, when the user does image classification training using a machine learning service, a training model is specified as being made up of an input layer, six convolutional layers conv (each layer contains 10 neurons, and an activation function is a sigmoid function), a flatten layer, four fully-connected layers “dense” (each layer contains 10 or 15 neurons, and an activation function is a rectified linear unit relu), and an output layer, as described above.

The throughput of the training data is specified as 10,000 RGB images with an image size of 64 by 64 pixels.

Besides, on the service requirement specification unit 11B of the ML requirement specifying functional unit 11, the upper limit of one training time is specified to be 0.05 sec. via the machine learning performance requirement specification unit, and an in-VM CPU resource utilization range is specified to be 30% to 60% and an in-VM memory resource utilization range is specified to be 10% to 40% via the VM performance requirement specification unit.

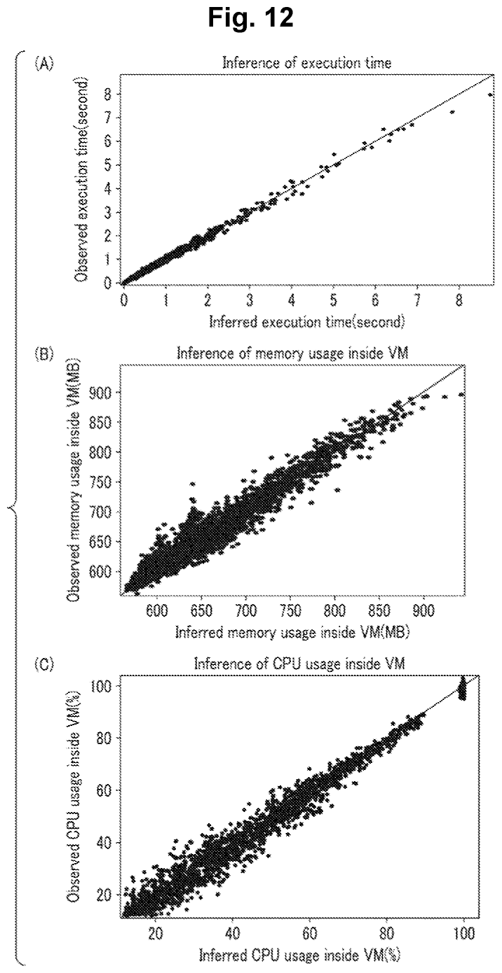

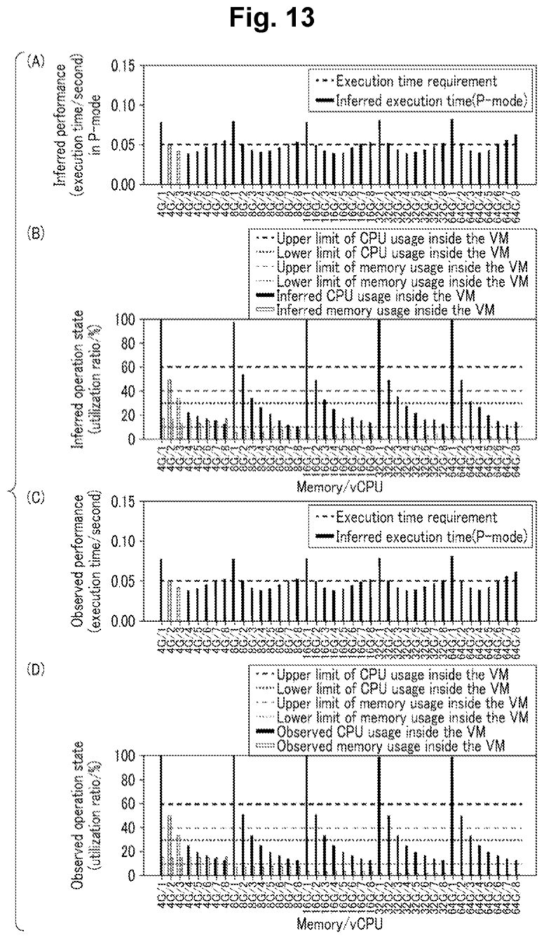

At each of the resource settings described above, a machine learning task specified by the user was executed in an actual cloud environment, and performances such as shown in FIGS. 13(A) to 13(D) were measured.

FIGS. 13(A) to 13(D) are diagrams showing prediction results and actual measurement results at resource settings specified by the user in a cloud environment. FIG. 13(A) is a diagram showing predicted execution time at each resource setting. FIG. 13(B) is a diagram showing predicted in-VM CPU and memory utilization rates at each resource setting. FIG. 13(C) is a diagram showing measured execution time at each resource setting. FIG. 13(D) is a diagram showing measured in-VM CPU and memory utilization rates at each resource setting.

In FIG. 13(A), the abscissa represents resource settings (memory/the number of vCPUs) and the ordinate represents predicted execution time at each resource setting. In FIG. 13(A), the thick broken line indicates an upper limit of the predicted execution time (=0.05 sec.) in P mode.

As illustrated in FIG. 13(A), by assuming that the resource settings of “4G/2 (the memory capacity is 4 Gbytes and the number of vCPUs is 2)” and “4G/3” can satisfy the upper limit of predicted execution time and the upper and lower limits of in-VM CPU and memory utilization rates as user requirements, these resource settings are indicated by hatched bar graphs in distinction from other resource settings.

In FIG. 13(B), the abscissa represents resource settings (at each setting, the black bar on the left side indicates the memory and the white bar on the right side indicates the number of vCPUs) and the ordinate represents predicted in-VM CPU and memory utilization rates (%). In FIG. 13(B), the thick broken line indicates the upper limit of the predicted in-VM CPU utilization rate (=60%), the thick dotted line indicates the lower limit of the predicted in-VM CPU utilization rate (=30%), the thin broken line indicates the upper limit of the predicted in-VM memory utilization rate (=40%), and the thin dotted line indicates the upper limit of the predicted in-VM CPU utilization rate (=10%).

As illustrated in FIG. 13(B), by assuming that the resource settings of “4G/2 (the memory capacity is 4 Gbytes and the number of vCPUs is 2)” and “4G/3” can satisfy the upper limit of predicted execution time and the upper and lower limits of in-VM CPU and memory utilization rates as user requirements, these resource settings are indicated by hatched bar graphs in distinction from other resource settings.

In FIG. 13(C), the abscissa represents resource settings (memory/the number of vCPUs) and the ordinate represents measured execution time actually measured when processing is performed according to user-specified requirements with the VM implemented according to each resource setting. In FIG. 13(C), the thick broken line indicates the upper limit of the measured execution time (=0.05 sec.).

As illustrated in FIG. 13(C), by assuming that the resource settings of “4G/2 (the memory capacity is 4 Gbytes and the number of vCPUs is 2)” and “4G/3” can satisfy, as predicted, the upper limit of predicted execution time and the upper and lower limits of in-VM CPU and memory utilization rates as user requirements, these resource settings are indicated by hatched bar graphs in distinction from other resource settings.

In FIG. 13(D), the abscissa represents resource settings (at each setting, the black bar on the left side indicates the memory and the white bar on the right side indicates the number of vCPUs) and the ordinate represents measured in-VM CPU and memory utilization rates (%) actually measured when processing is performed according to user-specified requirements with the VM implemented according to resource settings. In FIG. 13(D), the thick broken line indicates the upper limit of the measured in-VM CPU utilization rate (=60%), the thick dotted line indicates the lower limit of the measured in-VM CPU utilization rate (=30%), the thin broken line indicates the upper limit of the measured in-VM memory utilization rate (=40%), and the thin dotted line indicates the upper limit of the measured in-VM CPU utilization rate (=10%).

As illustrated in FIG. 13(D), by assuming that the resource settings of “4G/2 (the memory capacity is 4 Gbytes and the number of vCPUs is 2)” and “4G/3” can satisfy, as predicted, the upper limit of measured execution time and the upper and lower limits of in-VM CPU and memory utilization rates as user requirements, these resource settings are indicated by hatched bar graphs in distinction from other resource settings.

When the prediction results of FIGS. 13(A) and 13(B) are compared with the measurement results of FIGS. 13(C) and 13(D), the prediction results show that performance at each resource setting can be predicted with high accuracy, making it possible to confirm that all resource settings that can sufficiently satisfy user requirements can be selected.

The output section 12E of the resource design unit 12 receives resource design results selected by the determination section 12D through determination based on prediction results, converts the received results, i.e., recommended resources and predicted performance, into specified format, such as HTTP request, specified by the service requirement specification unit 11B, and transmits the results to the service requirement specification unit 11B of the ML requirement specifying functional unit 11.

The output section 12E also converts recommend resource settings, which are resource design results, into data format, such as yaml, specified by the resource management unit 13 and outputs the recommend resource settings to the resource management unit 13.

The resource management unit 13 carries out an actual machine learning service using resource settings designed by the ML requirement specifying functional unit 11 and the resource design unit 12.

As described in detail above, the present embodiment makes it possible to eliminate the need for a resource design process needed by the user in using a machine learning service and thereby reduce the time and costs which impose a burden on the user.

Note that in the above embodiment, prediction results on a machine learning service produced by the resource design unit 12 is converted into graphic display data and displayed by the resource design display unit 11C of the ML requirement specifying functional unit 11. This makes it easy for the user to visually identify resource settings that satisfy specified performance.

The device according to the present invention can also be implemented by a computer and program, and the program can be either recorded on the recording medium or provided via a network.

Besides, the present invention is not limited to the embodiment described above, and may be modified in various forms in the implementation stage without departing from the gist of the invention. Embodiments may also be implemented in combination as appropriate whenever possible, offering combined effects. Furthermore, the above embodiment includes inventions in various stages, and various inventions can be extracted through appropriate combinations of the disclosed components. For example, even if some of all the components shown in the embodiment are removed, the resulting configuration can be extracted as an invention as long as the configuration can solve the problem described in Technical Problem and provide the effects described in Effects of the Invention.

### REFERENCE SIGNS LIST

10 Machine learning service device
11 ML requirement specifying functional unit
11A Machine learning specification unit
11B Service requirement specification unit
11C Resource design display unit
12 Resource design unit
12A Log data collection section
12B Model generation section
12C Prediction section
12D Determination section
12E Output section
13 Resource management unit

1. A machine learning service device comprising:
a requirement specifying functional unit used to specify a task, a model, throughput, and performance that are desired in machine learning; and
a resource design unit configured to predict achievable performance at a plurality of resource settings by machine learning using the task, the model, and the throughput specified via the requirement specifying functional unit and select a resource setting that satisfies the specified performance based on results of the prediction.

2. The machine learning service device according to claim 1, wherein:
the resource design unit converts performance prediction results at a plurality of resource settings into display data; and
the requirement specifying functional unit presents a display based on the display data of the performance prediction results obtained by the resource design unit.

3. A machine learning service method comprising:
a requirement specifying functional step of specifying a task, a model, throughput, and performance that are desired in machine learning; and
a resource design step of predicting achievable performance at a plurality of resource settings by machine learning using the task, the model, and the throughput specified in the requirement specifying functional step and selecting a resource setting that satisfies the specified performance based on results of the prediction.

4. A program that makes a processor of the machine learning service device according to claim 1 perform processes of components of the machine learning service device.
